(19) United States
(12) Patent Application Publication
(10) Pub. No.: US 2023/0286690 A1
(43) Pub. Date: Sep. 14, 2023

(54) LABELING SYSTEM AND FLEXING LABEL APPLICATOR

(71) Applicant: ID Technology LLC, Ft. Worth, TX (US)

(72) Inventors: Matthew D. McLEAN, Monkton, MD (US); Ronald Lee SCHMOKER, Littleton, CO (US)

(21) Appl. No.: 18/086,292

(22) Filed: Dec. 21, 2022

Related U.S. Application Data
(63) Continuation-in-part of application No. 17/903,678, filed on Sep. 6, 2022, now Pat. No. 11,697,520.
(60) Provisional application No. 63/317,709, filed on Mar. 8, 2022.

(51) Int. Cl. B65C 9/36; B65C 9/02

(52) U.S. Cl. CPC B65C 9/36; B65C 9/02

(57) ABSTRACT

A label applying system includes a conveyance path for moving an item in a conveyance direction, a printer for printing and dispensing a label, the printer having opposite first and second sides, the printer having a label output at the first side, and a label applicator comprising an elongated label applying arm pivotably moveable between a label load position spaced away from the item and a label apply position in which a free end of the arm is moved into contact with the item. A pivot axis of the elongated label applying arm is located toward the second side of the printer and the elongated label applying arm extends across the printer to position an end of the elongated label applying arm at the label output toward the first side of the printer.

### TECHNICAL FIELD

The present application relates generally to label applying and, more particularly, to a label applying system for labeling items conveyed along a path.

### BACKGROUND OF THE INVENTION

Material handling systems are used in many different industries and often include complex packaging and conveyor systems that convey items, such as cases (boxes) or pallets, quickly from one place to the next within a facility or multiple facilities. Labeling is often necessary to convey information about the cases so that the cases can be identified, categorized, and/or properly routed, among other reasons.

Various label applicators are known. However, a label applicator that effectively applies labels to conveyed items, even when the conveyed items are offset from an expected orientation, would be desirable.

### SUMMARY OF THE INVENTION

In one aspect, a label applying system includes a conveyance path for moving an item in a conveyance direction, a printer for printing and dispensing a label, the printer having opposite first and second sides, the printer having a label output at the first side, and a label applicator comprising an elongated label applying arm pivotably moveable between a label load position spaced away from the item and a label apply position in which a free end of the arm is moved into contact with the item. A pivot axis of the elongated label applying arm is located toward the second side of the printer and the elongated label applying arm extends across the printer to position an end of the elongated label applying arm at the label output toward the first side of the printer.

In another aspect, a label applying system includes a conveyance path for moving an item in a conveyance direction, and a label applicator comprising an elongated label applying arm pivotably moveable between a label load position spaced away from the item and a label apply position in which a free end of the elongated label applying arm is moved into contact with the item. The elongated label applying arm is configured to be sufficiently flexible such that at least a label carrying portion of the elongated label applying arm bends, as it moves into contact with the item, for pressing a label against the item.

In a further aspect, a label applying system includes a conveyance path for moving an item in a conveyance direction, a label printer with a label output, and a label applicator with an elongated label applying arm pivotably moveable between a label load position spaced away from the item and in which a free end of the elongated label applying arm is located proximate the label output and a label apply position in which the free end of the elongated label applying arm, with a given label thereon, is moved into contact with the item. The elongated label applying arm is configured to be sufficiently flexible such that at least the free end of the elongated label applying arm bends, as the free end moves into contact with the given item, for pressing the given label against the item.

In yet a further aspect, a label applying system includes a label print unit with an associated label output, a motor, a shaft connected to the motor for being rotated by the motor, and an elongated label applying arm connected to the shaft for pivotable movement between a label load position and a label apply position. The elongated label applying arm includes a label carrying free end portion that is positioned to receive labels from the label output when the elongated label applying arm is in the label load position, wherein the elongated label applying arm is configured to be sufficiently flexible such that the elongated label applying arm bends, as the elongated label applying arm moves into contact with an item, for pressing a label against the item.

In another aspect, a method of applying a label to an item moving along a conveyance path involves the steps of: feeding the label onto a free end of a label applying arm, where the free end is spaced away from a movement path of the item; pivoting the label applying arm to move the free end, with the label thereon, toward the movement path and into contact with the item; wherein the label applying arm is configured to be sufficiently flexible such that at least the free end of the label applying arm bends, as the free end moves into contact with the item, for pressing the label against the item.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of a label applying system;

FIG. 2 is another perspective view of the system;

FIGS. 3-5 are partial top plan views of the system applying labels to items in different orientations;

FIG. 7 is a perspective view of another embodiment of a label applying system;

FIG. 8 is a top plan view of the system of FIG. 7;

FIG. 9 shows an elevation view of another embodiment of a label applying system;

FIG. 10 is a top plan view of various label applier configurations and positions; and

FIG. 11 shows an elevation view of another embodiment.

### DETAILED DESCRIPTION

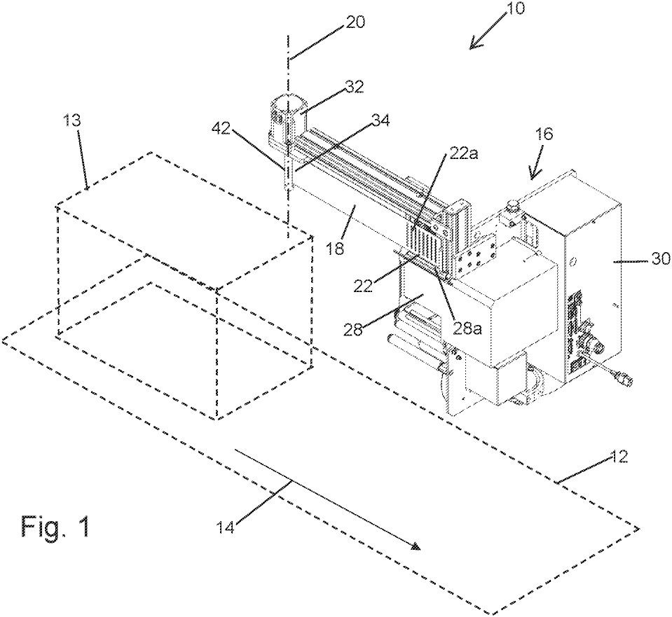

Referring to FIGS. 1-6, a label applying system 10 includes a conveyance path 12 (e.g., formed by any suitable conveyor technology, such as a roller conveyor or belt conveyor) for moving items, along an item conveyance path 13a in a conveyance direction 14, and a label print and apply unit 16. Here, the label print and apply unit 16 is arranged alongside the conveyance path 12 and includes a label applying arm, here an elongated label applying arm 18, that is pivotably moveable, via rotation about a pivot axis 20, between a label load position 18a spaced away from the item and a label apply position (e.g., 18b, 18c, 18d) in which a free end 22 of the elongated label applying arm 18 is moved into contact with the item.

Here, the label print and apply unit includes a support arm 24 for holding a label stock supply roll, an arm 26 for holding a label backing take-up roll, a label print unit 28 and a control system 30. The label print unit 28 includes a label output 28a positioned to feed printed labels onto a label carrying portion of the elongated label applying arm 18, which, in this case, is at the free end 22 of the elongated label applying arm. A motor 32 (e.g., a servomotor) is operatively connected to a drive end 34 of the elongated label applying arm for effecting pivot of the elongated label applying arm about the pivot axis 20.

By way of example, in embodiments, the motor 32 is configured to pivot the elongated label applying arm with a torque of at least 0.14 nm (e.g., at least 0.16 nm) and/or at a rotational acceleration of at least 400 degrees/second (e.g., at least 450 degrees/second), ignoring elongated label applying arm flex. In embodiments, the elongated label applying arm 18 has a length L of between eight inches and twenty-four inches (e.g., between twelve inches and twenty inches, such as between fourteen inches and eighteen inches).

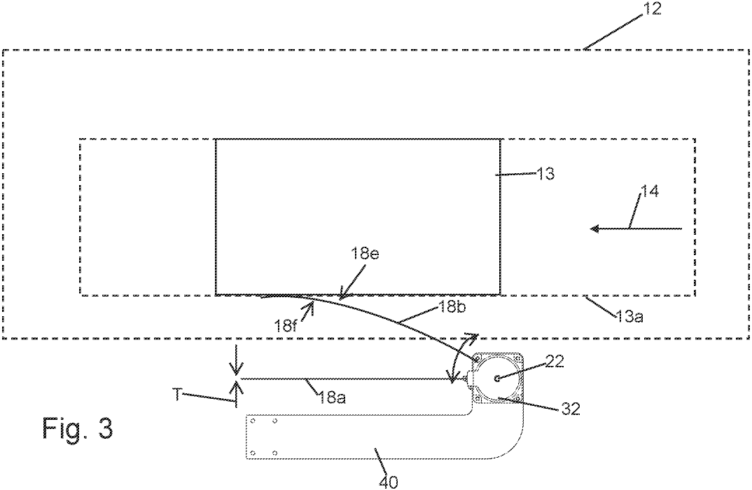

Notably, the elongated label applying arm is configured to be sufficiently flexible such that at least the label carrying portion of the elongated label applying arm bends, including bending of the label contacting surface of the label carrying portion, as the label carrying arm moves into contact with the item, for pressing a label against the item, per elongated label applying arm position 18b shown in FIG. 3. When the elongated label applying arm is in the label load position depicted by 18a, the elongated label applying arm is generally planar (e.g., formed of a thin sheet material or thin plate material). The elongated label applying arm is also configured so as to have shape memory (e.g., elastically bendable), which causes the elongated label applying arm to move back to the planar configuration when the elongated label applying arm pivots out of contact with the item 13. In some embodiments, the elongated label applying arm 18, or at least the label carrying portion that bends upon contact with items, is formed of a carbon fiber material, which is particularly light and durable. In such carbon fiber embodiments, a thickness T of between about 1.0 mm and about 2.0 mm in combination with a 0/90 weave of carbon fibers, with the fibers running parallel to the elongated label applying arm length and perpendicular to the elongated label applying arm length, has been found to be desirable, but variations are possible. Arms of other materials, that are configured to be sufficiently flexible, are also possible.

In the illustrated embodiment per FIG. 3, substantially the full length of the elongated label applying arm 18 is flexible and, therefore, during label application, some bend occurs along a majority (i.e., greater than 50% (e.g., 60% or more)) of the length L of the elongated label applying arm, but with a greater amount of bend occurring at the free end, resulting in a bend of continuous curve form as shown in the drawings.

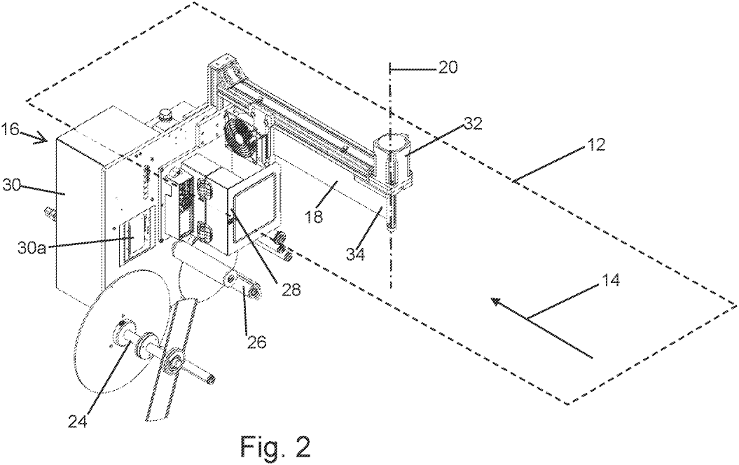

Here, the free end 22 of the elongated label applying arm includes a plurality of openings 22a that pass through the elongated label applying arm from a label carrying side 18e of the elongated label applying arm to the opposite side 18f of the elongated label applying arm. When the elongated label applying arm 18 is in the label load position of FIGS. 1 and 2, an air mover 36 (e.g., a fan) is operatively associated with the free end to create a pressure drop across the elongated label applying arm, via the plurality of openings 22a, so as to hold a label on the label carrying portion once the label is fed by the label print unit 28. When the elongated label applying arm moves toward the label apply position, the air mover, which does not move with the elongated label applying arm 18, is no longer operatively associated with the free end 22. However, the acceleration of the pivoting elongated label applying arm, in combination with frictional forces between the elongated label applying arm and the label, are sufficient to keep the label on the elongated label applying arm until the free end of the elongated label applying arm pushes the label into contact with the item 13.

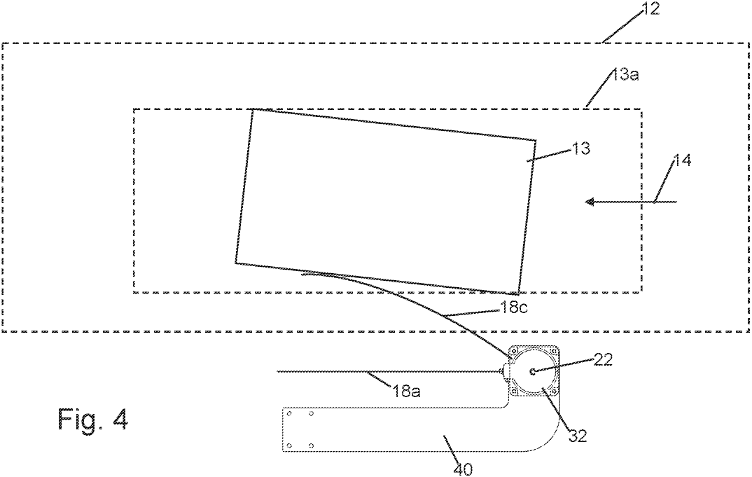

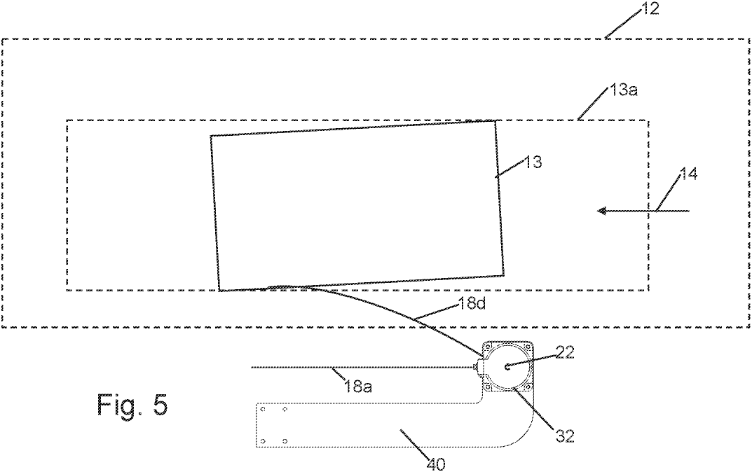

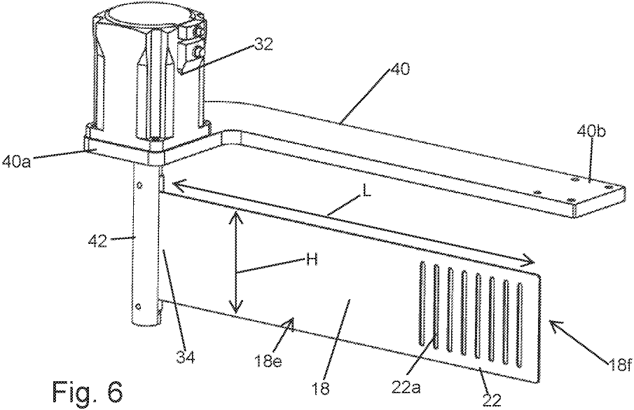

Notably, the use of the flexible elongated label applying arm 18 to apply labels to moving items facilitates application of labels to items even when the items are not in an expected or desired orientation. For example, FIGS. 4 and 5 show exemplary label applying positions 18c and 18d of the elongated label applying arm when the item 13 is askew (i.e., the side of the item is not parallel to the movement direction 14).

As suggested in FIGS. 3-6, in embodiments, the motor 32 may be positioned at one end 40a of a rigid mount arm 40, where the opposite end 40b of the arm 40 is used for connection to the rest of the label print and apply unit 16. A drive shaft 42 extends from the motor 32 and the drive end 34 of the elongated label applying arm 18 is connected to the shaft 42. Here, the elongated label applying arm is directly connected to the motor shaft 42 for rotation by the motor 32. Also, the rigid mount arm 40 is of a rigid support plate configuration, with the motor 32 mounted on one side face 40c of the support plate in alignment with a plate opening 40d through which the drive shaft 42 extends.

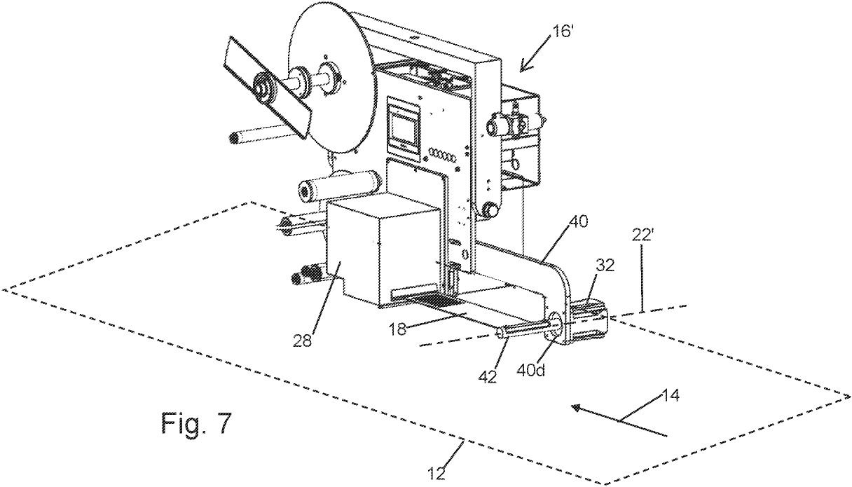

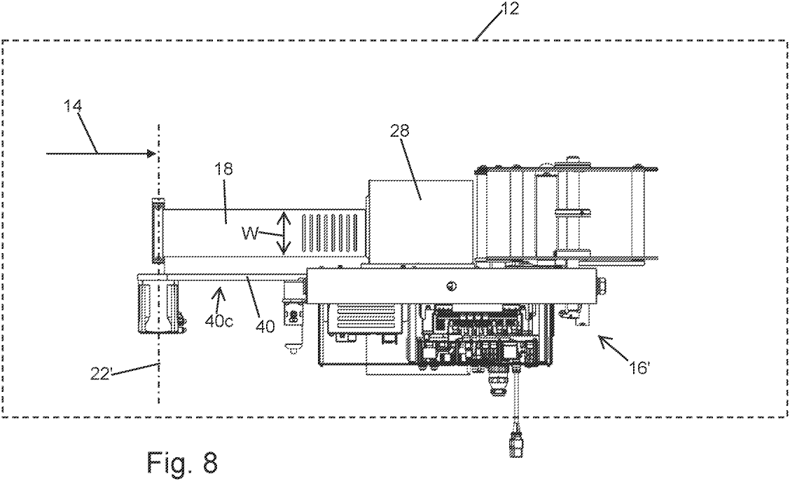

Although the above-described embodiment depicts an arrangement in which the label applying arm 18 is configured to pivot around a vertical pivot axis 22 towards the moving items, other arrangements are possible. For example, FIGS. 7 and 8 depict an arrangement in which the label print and apply unit 16’ is configured such that the label applying arm 18 is oriented and positioned to apply labels downward onto items by pivoting around a horizontal pivot axis 22′.

The embodiments above all provide a method of applying a label to an item moving along a conveyance path, the method including: feeding the label onto a free end of a label applying arm, where the free end is spaced away from a movement path 13a of the item; pivoting the label applying arm to move the free end, with the label thereon, toward the movement path and into contact with the item; wherein the label applying arm is configured to be sufficiently flexible such that at least the free end of the label applying arm bends, as the free end moves into contact with the item, for pressing the label against the item.

In embodiments, the control system 30 is configured to rotate the elongated label applying arm in a controlled manner. For example, the control system 30 is configured to rotate the elongated label applying arm from the label load position to a location specified in the control system program, which location may be modified by the customer (e.g., via a user interface 30a). For example, a target rotation angle of between 50 degrees and 120 degrees may be specified (e.g., 110 degrees for an intended application of a label to the front side of a moving box/carton or 60 degrees for an intended application of a label to a lateral side of a moving box/carton). After reaching the target rotation angle, the control system may cause the arm to rotate back to the label load position immediately, as reaching full rotational swing may not be desirable. If the control system detects (based upon servo-motor feedback) application of force to the arm during rotation toward the target rotation angle, or the arm contacting something via being out of position, the control system may dwell the arm position for a user selectable time (e.g., 0 to 1,000 milliseconds), while maintaining a user selectable force of the arm in contact with the item being labeled, and then effects rotation of the arm back to the label load position. For an intended corner wrap label application in which part of the label is applied to the front side and part of the label is applied to the lateral side, the control system may initially rotate the arm toward a target rotation angle of, for example, 100 degrees and, upon detection of arm contact with the item, change to a lesser target rotation angle (e.g., 40-60 degrees) to enable the label to be “wiped” around the corner of the box/carton and onto the lateral side. The control system may utilize one or more item detecting sensors to trigger the printing and dispensing of the label onto the arm and subsequent motor operation to pivot the arm from the label load position toward the label apply position.

Although the illustrated elongated label applying arms have a substantially uniform dimension perpendicular to the length, variations are possible, such as arms in which a portion of the arm between the drive shaft and the label carrying portion have a smaller dimension (height H or width W depending on elongated arm orientation) than the corresponding dimension of the label carrying portion, enhancing flexibility of such portion of the arm. Variations in which both the motor shaft engaging arm portion and the label carrying arm portion have a larger height or width dimension, as compared to an intermediate arm portion extending between the motor shaft engaging arm portion and the label carrying arm portion, are also possible.

In some embodiments, for a given size, particularly length, of the elongated label applying arm, a relatively low moment of inertia is seen by the motor. This relatively low moment of inertia is, in part, achieved by the use of a relatively thin sheet material for the elongated label applying arm, which results in a relatively low mass per unit surface area for the arm. By way of example, implementation of arms having a mass per unit label side facing surface area of no more than 0.00650 pounds per square inch (e.g., such as no more than 0.00500 pounds per square inch, or no more than 0.00400 pounds per square inch) have been found desirable, where the label side facing surface area is the total surface area of the arm face that includes the surface that carries the label (e.g., H x L in the embodiment of FIG. 6).

In some embodiments, to provide a desired flexibility, the label carrying portion of the elongated label applying arm has a flexural modulus of no more than 10 msi (e.g., no more than 8 msi, such as no more than 6 msi, such as no more than 5 msi), calculated using the known formula (L³*F)/(4*W*H³*D).

The foregoing is provided for purposes of illustrating, explaining, and describing embodiments of labeling apparatus. Modifications and adaptations to these embodiments will be apparent to those skilled in the art and may be made without departing from the scope or spirit of this application.

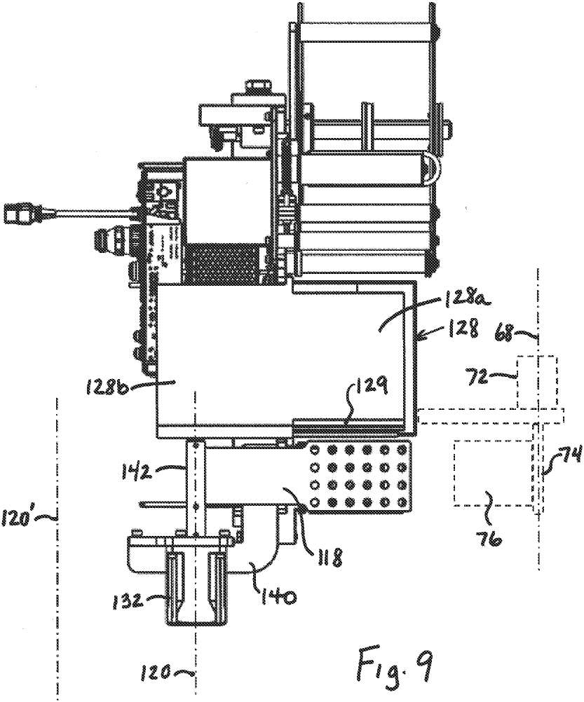

Referring now to FIG. 9, which is an exemplary elevation view looking from the conveyance path, an embodiment that is particularly useful, in terms of providing various installation configurations along both sides of a conveyance path, is described. Notably, the previously depicted embodiments show configurations in which the pivot axis of the label applying arm is on the side of the printer at which the label exits the printer. In FIG. 9, such a position/arrangement is shown by the dashed line pivot axis 68, mount arm 70, motor 72, shaft 74 and label applying arm 76. In the alternative configuration (aka a “reverse applicator”), the pivot axis 120 of the motor 132, shaft 142 and label applying arm 118 is located on the other side of the printer 128 as shown (e.g., here 128a is the right side and 128b is the left side) from the side of the label output slot or opening 129. Here, the pivot axis 120 is within the lateral footprint of the printer, but the pivot axis could be outside the lateral footprint, per position 120′, in which case a longer label applying arm would be used.

By positioning the pivot axis and label applying arm in this manner, the same printer 128, which here is a “right-hand” printer as known in the art because the label exits on the right side of the printer, can be used to apply labels to each of the leading side, the lateral side and the trailing side of a moving box/carton. In the past, in order to achieve desired application of labels to each of the leading, lateral and trailing sides, with the labels applied in the proper orientation and printed from the same image file, it was necessary to use both a left-hand printer and a right hand printer.

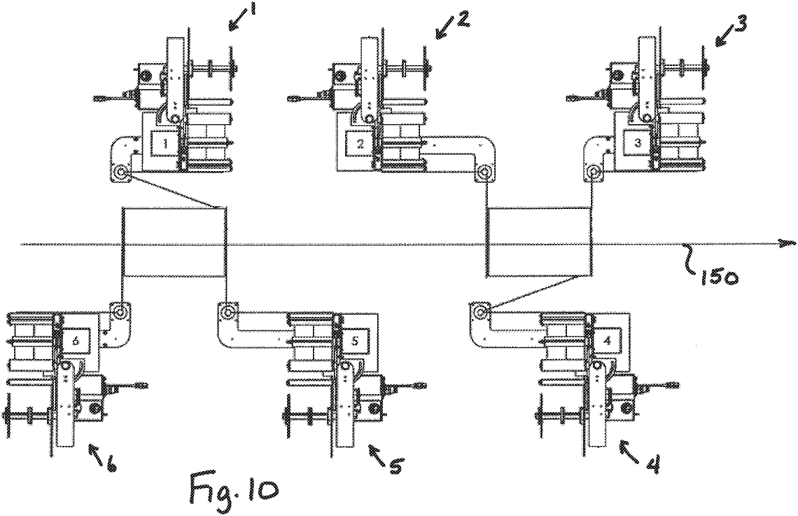

To further demonstrate the benefit, reference is made to FIG. 10 showing various label applying system positions represented 1, 2, 3, 4, 5 and 6, where (i) all positions utilize right hand printer, (ii) system positions 2, 4 and 5 show a traditional configuration where the label applying arm pivot axis is on the side of the printer that is the same as the side at which the label outputs from the printer and (iii) system positions 1, 3 and 6 show the configuration in which the label applying arm pivot axis is on the side of the printer that is opposite the side at which the label outputs form the printer. Here, system positions 1, 2 and 3 are on one side of the item movement path 150, which moves items from left to right here, and system positions 4, 5 and 6 are on the opposite side of the item movement path 150. System positions 1 and 4 apply the label to the lateral side of the box/carton, system positions 2 and 6 apply the label to the trailing side of the box/carton and system positions 3 and 5 apply the label to the leading side of the box/carton.

Without the reverse applicator, configurations 1, 3 and 6 would need to use a left-hand machine, with left hand printer, in order to apply the label as desired while requiring a unique print image format. With the reverse applicator configuration, any panel of the product can be labeled using a standard right-hand machine (and right hand printer) using the same print image format. By providing a reverse applicator configuration, in addition to the normal applicator configuration, any panel of the product can be labeled using a standard right-hand machine (and right hand printer) and the print string or software is exactly same for reach position and the spare parts required for the printer are exactly the same.

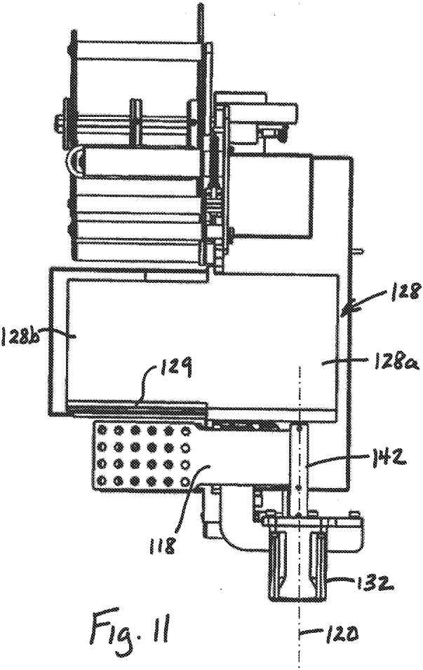

The reverse application configuration can also be provided with a left-hand machine (and left hand printer), in addition to the normal applicator configuration, to achieve similar benefits. In such a case, the system would be oriented per the example of FIG. 11.

Notably, in FIG. 10, all of the label applying arm lengths are identical, and it is seen that the reverse applicator configuration is also more compact. This reverse applicator configuration allows for more open access to the front (operator side) of the machine, and allows the machine to be placed closer to an obstacle, etc.

Other modifications and variations are also possible.

1. A label applying system, comprising:
a conveyance path for moving an item in a conveyance direction;
a printer for printing and dispensing a label, the printer having opposite first and second sides, the printer having a label output at the first side;
a label applicator comprising an elongated label applying arm pivotably moveable between a label load position spaced away from the item and a label apply position in which a free end of the arm is moved into contact with the item;
wherein a pivot axis of the elongated label applying arm is located toward the second side of the printer and the elongated label applying arm extends across the printer to position an end of the elongated label applying arm at the label output toward the first side of the printer.

2. The label applying system of claim 1, wherein the elongated label applying arm is a flexing arm.

3. The label applying system of claim 2, wherein the elongated label applying arm is configured to be sufficiently flexible such that at least a label carrying portion of the elongated label applying arm bends, as it moves into contact with the item, for pressing a label against the item.

4. The label applying system of claim 1, wherein the first side is the right side of the printer, as viewed in elevation view from the conveyance path, and the second side is the left side of the printer.

5. The label applying system of claim 1, wherein the first side is the left side of the printer, as viewed in elevation view from the conveyance path, and the second side is the right side of the printer.
